(19) United States
(12) Patent Application Publication
(10) Pub. No.: US 2006/0180564 A1
(43) Pub. Date: Aug. 17, 2006

(54) Compact hoist for drilling or workover rig

(76) Inventor: James R. Keppel, The Woodlands, TX (US)

Correspondence Address: STREETS & STEELE, 13831 NORTHWEST FREEWAY, SUITE 355, HOUSTON, TX, 77040, US

(21) Appl. No.: 11/034,485

(22) Filed: Jan. 13, 2005

(51) Int. Cl. B66C 19/00

(52) U.S. Cl. 212/330

(57) ABSTRACT

The present invention provides a compact hoist system for use on a drilling or workover rig. The present invention eliminates problems related to chain failures in hoist systems by incorporating wire rope in a vertically and horizontally compacted arrangement to provide maximum vertical lift capacity and improved versatility. Caterpillar bearings, wire rope tension equalizing sheaves and a winch coupled to a axially movable spiral-grooved drum are combined to provide a system that enables cantilever jack-up rigs to handle blow-out preventer stacks of increased height and size.

### BACKGROUND OF THE INVENTION

1. Field of the Invention

The present invention relates to a hoist system for use on a drilling or workover rig. Specifically, the present invention relates to a vertically and horizontally compact hoist system having an expanded range of motion, improved maneuverability, faster operation and improved safety.

2. Description of the Related Art

Drilling rigs are versatile because they can be utilized both for the offshore drilling of new wells and for workovers on existing offshore wells. These drilling and workover rigs require robust hoist systems for transferring equipment or materials to or from the wellhead.

An important piece of equipment handled by hoist systems on a rig is the blowout preventer stack. Blow-out preventers (BOPs) are devices that are secured to a wellhead to enable rapid isolation and containment of the well in the event of a well control problem. A BOP is essentially a large valve installed at the top of a well that may be closed to prevent the loss of control of a well. A BOP (usually operated remotely by hydraulic actuators) may be used to control and contain hydrocarbon reservoirs in fluid communication with the well. After the well is contained using BOPs, steps can be taken to increase the hydrostatic pressure of the mud column in the well to contain and control the well for resumed operations.

BOPs come in a variety of styles, sizes and pressure ratings. Some BOPs are designed to seal off an open wellbore, others are designed to seal around tubular members in the well (such as drillpipe, casing or tubing), and still others are fitted with shearing tools that are designed to cut through a drillpipe. In addition to a BOP for sealing off an open wellbore, a BOP may be required for each diameter of pipe that is installed or removed from a well.

BOPs are generally adapted for being secured to other BOPs in a configuration that allows access to the wellbore through aligned ports in the BOPs. A “stack” of BOPs may comprise numerous BOPs. For example, one BOP may be fitted for containment around a 5-in. diameter drillpipe, a second BOP may be fitted for 4.5-in. drillpipe, a third BOP may be fitted with blind rams to close on the open hole, and a fourth BOP may fitted with a shearing ram that can cut the drillpipe (as a last resort to control the well). It is common to have one or two specially adapted BOPs, called annular preventers, at the top of the BOP stack. Annular preventers can typically be closed around a range of tubular sizes or over an open hole, but are generally not designed to contain high pressures that can be more effectively contained by ram-type preventers.

FIG. 2 is an elevational view of a typical prior art BOP stack. The illustrated BOP stack includes multiple sets of rams and annular preventers secured in a stack. A BOP stack also includes various spools, adapters and piping outlets to permit the circulation of weighted wellbore fluids into a well that is contained by the BOP stacks. These accessories provide a means of increasing the hydrostatic weight of the mud column in the wellbore while the well is contained by the BOPs.

BOP stacks can weigh many tons when fully assembled, and they must be assembled, stored on a rig and installed on and removed from the wells during well operations. Typically, BOP stacks are assembled and stored onboard the rig but clear of the well. The BOP storage area is typically adjacent to and accessible by the hoist system that is movably coupled to an I-beam using at least one trolley that travels along the I-beam along the underside of a platform. The fully assembled BOP stack is stored on an upwardly protruding “stump” that provides vertical stability when it is received into the aligned port at the bottom of the BOP stack. When the BOP is transferred to the well, the BOP stack is coupled to the block of the hoist system, lifted vertically off of the stump and moved into position over the well by using the trolley. The hoist then lowers the BOP onto the well where it is secured.

FIG. 1 is a perspective view of a typical prior art hoist used on a rig for transferring equipment or materials to or from an offshore well. These prior art hoists typically use drive systems (not shown), such as air-powered motors, for driving a high-reduction gearbox (not shown) that, in turn, powers a chain winch. The motor, gearbox and winch are typically mounted on and supported by one or more trolleys that travel along I-beams contained within the structure of the underside of a drilling rig. Pressurized fluid is generally supplied to the drive system using one or more flexible supply hoses that accommodate movement of the trolley(s) along the I-beam.

Prior art hoist systems for handling BOP stacks on offshore rigs typically use chain instead of wire rope. The length of the chain must be long enough to engage all sheaves on the block and to secure them to the winch when the block is at its lowest position. This may require more than 300 feet of chain that must be accumulated in and retrieved from a large chain bucket. The entire length of chain, the chain storage bucket, the drive system, gearbox and chain winch are all secured to and move with the trolley. A chain pocket wheel receives a chain link into a recess, and the chain pocket wheel is slowly turned by a gearbox powered by a drive system.

The presence of the drive system, gearbox, chain pocket wheel and chain bucket onboard and moving with the trolley impairs the horizontal range of motion and the maximum vertical lift capacity of the prior art hoist systems. Since the prior art hoist systems position the chain pocket wheel directly over the load, the winch must be physically disposed between the movable trolley and the lifting block, thereby impairing the maximum vertical lift capacity of the hoist system. The bulky arrangement of the multiple gears in the gear box, the drive system and the chain bucket on the trolley impairs the horizontal range of motion and related lift zone of the prior art chain hoist system.

Finally, the lift speed of chain hoists depends in part on the compatibility of the chain pocket wheel with high-speed operation. Chain pocket wheels will malfunction if operated at medium angular velocities, and any deviation from vertical in the chain feed as it engages the chain pocket may also result in malfunction.

Another problem with chain hoist systems for handling BOP stacks is that the interaction of a chain link with the adjacent chain link causes metallurgical deformation that may lead to catastrophic failure of the chain hoist. For example, if a load hanging from a block having three sheaves weighs 12 tons, then the tension of in the chain is about one-sixth that of the load (plus the weight of the block), or about 4,000 pounds. As the chain pocket wheel raises a chain link that is received within the chain pocket wheel, the chain link is slightly rotated from its vertical position while the adjacent chain link remains generally vertical. This forcible disalignment of adjacent chain links while under load causes undesirable sliding contact, localized surface wear and possible cracking in the “U” portion of the chain links. In an offshore marine environment, surface cracking may result in catastrophic chain failure due to stress corrosion cracking or some other mode of corrosive or mechanical failure.

Wire rope is typically not used on hoists for transferring BOP stacks from a rig to an offshore well. Unlike chain, long lengths of wire rope must be stored on a drum in order to prevent tangling and damage, and wire rope storage drums must generally have a diameter more than 18 times the diameter of the stored wire rope to prevent inelastic deformation. Wire rope hoists require multiple wraps of the wire rope around the drum to grip and pull tension in the wire rope, while chains are structurally adapted for much shorter “lift lengths” because a chain link can be individually secured into and lifted by a chain pocket wheel. Although wire rope has a superior load bearing capacity as compared to an equal weight of chain, wire rope cannot be easily gripped or pulled in short lengths. The difficulty in adapting large wire rope storage drums for use on moving trolleys has prevented their use in hoist systems that handle BOP stacks on rigs.

As wells have become deeper, the ranges of the diameters of pipe that are used in wells during drilling or workover have increased resulting in the need for additional BOPs to be added to the stack and dramatically increasing the height and weight of the BOP stack that must be assembled, stored on the rig and transferred to and from the well. Since the winch is positioned vertically between the trolley and the block, the increased BOP stack height impairs the maximum height to which the block can be raised on a chain hoist. This configuration provides less vertical clearance, or “overhead,” between the stump on which the BOP stack is stored and the maximum vertical height of the block. If the top of the BOP stack is above or even with the block when raised to its maximum vertical height, the hoist system cannot safely lift the BOP stack to or from the stump.

Since space and weight are critical parameters on an offshore rig, a new approach to the design of the onboard hoist system is needed in order to increase the size of the BOP stacks that can be used by the rig. There is a need to retrofit existing offshore rigs with hoist systems that can safely handle the increased size and height of modern BOP stacks used to safely drill or workover deep wells. There is a need for a hoist system utilizing wire rope instead of chain in order to decrease the risk of loss due to stress corrosion cracking and other metallurgical failures that affect chain. There is a need for a hoist system for use on offshore rigs that also provides improved an expanded range of horizontal motion in order to utilize more rig storage area. There is a further need for a hoist system that provides faster lift speeds than is currently available from chain hoists.

### SUMMARY OF THE INVENTION

The present invention provides an improved hoist system for use on a rig that utilizes wire rope instead of chain and that eliminates chain failures, improves hoist speed and versatility, and expands the vertical and horizontal range of operation of the hoist system. Expanding the range of operation increases usable rig storage space and allows handling of larger BOP stacks as compared to chain hoists.

The present invention overcomes several shortcomings resulting from the use of chain hoists for transferring BOP stacks on a rig. The present invention enables the unloading of the trolley used to position the block over the load.

Where the chain used in a chain hoist is stored in and retrieved from a chain bucket that is secured to a moving trolley, the present invention provides a grooved drum that is operatively aligned with, but not secured to, the trolley for storage of the wire rope used in the hoist. Where tension in the chain to operate a chain hoist is provided by a chain pocket wheel and a gearbox that are secured to the trolley, the present invention provides tension to the wire rope using a winch comprised of a grooved drum with drive system. The drum and drive system combination are slidably mounted on a stationary base that allows the drum to move along its axis of rotation in a manner that provides uniform winding of the wire rope within a spiral groove on the circumference of the drum and that maintains the pathway of the wire rope aligned with the receiving sheave on the moving trolley.

This present invention provides a hoist that substantially unloads the trolley that positions the block for lifting the load to thereby provide increased overhead between the block and the stump on which the BOP stack is stored. Also, the present invention provides additional overhead by accommodating at least a portion of the block between the sheaves of the trolley so that the maximum vertical height attainable by the block is brought close to the bottom of the I-beam(s) on which the trolley travels.

The horizontal range of movement of the trolley is expanded by storage of the wire rope on a drum having a spiral groove on its circumference, thereby eliminating the chain bucket from the trolley. Range of movement is further expanded by enabling the removal of the gearbox and drive system to the remote location of the drum at the side of the cantilevered platform.

These changes, and others described below, provide for a vertically and horizontally more compact hoist system with corresponding improvements in both vertical and horizontal ranges of motion. Improved range of motion provides the capacity to handle larger BOP stacks and more usable storage space, a valuable commodity on a rig.

The present invention further provides an improved system for coupling the trolley to the lower flange of an I-beam within the structure of the cantilevered platform of an offshore rig. Instead of using conventional wheels to provide rolling support of the trolley along the top side of the lower flange of the I-beam, a plurality of pivoting caterpillar bearing assemblies, each comprising multiple elongated roller bearings captured in a housing, provides numerous points of load supporting contact to the trolley. The rollers are, in turn, pivotally coupled to a trolley support that is pivotally coupled to the trolley plate that supports the block. This design evenly distributes the load along the I-beam flange, while enabling the trolley to travel over irregular surfaces with minimal load vibrations that would otherwise result from irregularities in the I-beam flange.

The grooved drum is controllably rotated about its horizontal axis of rotation to reel in or pay out wire rope to raise or lower the block, respectively. The winch that is coupled to the drum through a gearbox may be powered by pressurized fluid, such as air or hydraulic fluid, electric motor or other drive system. The grooved drum, gearbox and drive system all translate on slides or bearings along the axis of rotation of the drum. Translation is controlled by stationary roller-followers that rollably engage the groove in the drum circumference to impart a translating force that compels the drum/winch/gearbox combination to slide along the axis of rotation as compelled by the roller-followers. The pitch of the spiral groove in the drum circumference and the diameter of the drum provide for a rate of drum translation along the axis of rotation, as compelled by the roller-followers, so that the section of wire rope between the drum and the trolley has little or no fleet angle.

The foregoing and other objects, features and advantages of the invention will be apparent from the following more particular description of a preferred embodiment of the invention, as illustrated in the accompanying drawing wherein like reference numbers represent like parts of the invention.

### BRIEF DESCRIPTION OF THE DRAWINGS

FIG. 1 is a perspective view of a typical prior art hoist used on a rig for transferring equipment or materials to or from an offshore well.

FIG. 2 is an elevational view of a typical prior art BOP stack.

FIG. 3 is a perspective view of one embodiment of the improved hoist system of the present invention coupled to an I-beam.

FIG. 4 is a perspective view of one embodiment of the improved hoist system of the present invention coupled to an I-beam.

FIG. 5 is an enlarged perspective view of one embodiment of the trolley portion of the improved hoist system of the present invention coupled to an I-beam.

FIG. 6 is an elevation view of one embodiment of the trolley portion of the improved hoist system of the present invention coupled to an I-beam with the block at a position lower than its maximum height.

FIG. 7 is an elevation view of one embodiment of the trolley portion of the improved hoist system of the present invention coupled to an I-beam with the block at its maximum height.

FIG. 8 is an end view of one embodiment of the trolley portion of the improved hoist system of the present invention coupled to an I-beam with the block at al position lower than its maximum height.

FIG. 9 is an overhead view of one embodiment of the trolley portion of the improved hoist system of the present invention.

FIG. 10 is a perspective view of one side of one embodiment of the trolley support structure of the trolley portion of the improved hoist system of the present invention in rolling contact with the top side of an I-beam bottom flange.

FIG. 11 is a perspective view of one side of one embodiment of the trolley portion of the improved hoist system of the present invention.

FIG. 12 is an elevation view of one side of one embodiment of the trolley support structure of the improved hoist system of the present invention showing the pivotal coupling between the trolley support member and the trolley plate that supports the sheaves.

FIG. 13 is a bottom view of one side of one embodiment of the trolley support portion of the trolley portion of the improved hoist system of the present invention.

FIG. 14 is an enlarged elevation view of a roller assembly pivotally coupled to one end of a trolley support of one embodiment of the improved hoist system of the present invention.

FIG. 15 is an overhead view of one embodiment of the improved hoist system of the present invention with the block at a position lower than its maximum height as evidenced by the length of wire rope paid out from the grooved drum.

FIG. 16 is an overhead view of one embodiment of the improved hoist system of the present invention with the block at its maximum height as evidenced by the length of wire rope stored on the grooved drum and the corresponding translation of the grooved drum along its axis of rotation.

FIG. 17 is an end view of the grooved drum of one embodiment of the present invention with the winch and gearbox coupled to the grooved drum and the roller-followers engaging the spiral groove of the drum.

FIG. 18 is an overhead view of the grooved drum of one embodiment of the present invention with the winch and gearbox coupled to the drum and the roller-followers engaging the spiral groove in the drum.

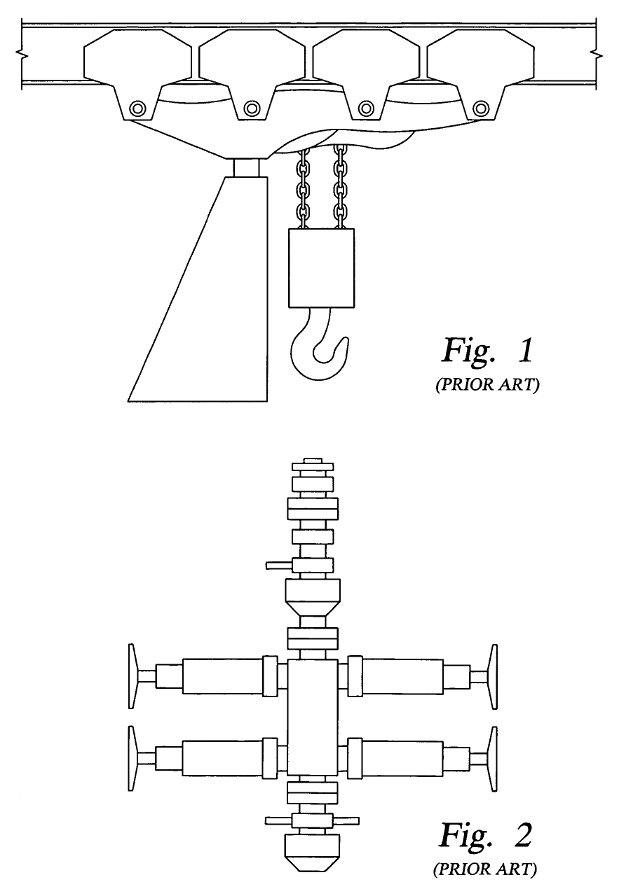

### DETAILED DESCRIPTION OF THE INVENTION

The present invention provides a hoist system and methods for its use that are useful for lifting and positioning equipment, such as BOPs, on an oil or gas well rig. For purposes of using the drawings to support the disclosure herein, it is required that terminology for referring to various similar or identical components of the invention be defined. In referring to the above-reference drawings, “proximal” is used to refer to components or portions of components disposed nearer to the grooved drum, and “distal” is used to refer to components or portions of components disposed nearer to the equalizing sheave that is opposite the grooved drum relative to the trolley portion. “Front” is used to refer to components or portions of components in the foreground of the above-referenced drawings relative to the I-beam center portion along which the trolley portion travels, and “rear” is used to refer to those components or portions of components on the opposite side of the I-beam center portion from the foreground.

As used herein, a sheave is a pulley having a uniform groove about its circumference for receiving a wire rope. Sheaves are generally rotatably mounted on an axle using friction reducing components, such as bearings. A pair of sheaves is two adjacent sheaves on the front of the trolley, or to two adjacent sheaves on the rear of the trolley, lying generally in the same plane and having their axes of rotation at generally the same vertical height. An “opposite” sheave is meant to refer to a sheave having a generally aligned axis of rotation but coupled to the trolley at a point across the center portion of an I-beam to which the trolley may be coupled.

A plate is a generally planar, but not necessarily flat, support member. A plate may be adapted to conform to a non-planar space and to couple with other components.

An ear is a member that is a part of and extends from a component, usually for pivotally coupling the component to another component.

No terms used herein to refer to special relationships, or to refer to identical or similar components in different locations or applications in connection with the present invention, are meant to suggest that “sister” components or portions of components are not interchangeable. In many structural aspects, the trolley of the present invention is symmetrical about the vertical plane containing the I-beam center portion along which the trolley portion travels and about the vertical plane that is perpendicular to the vertical plane containing the I-beam center portion along which the trolley portion travels. A specific component may be selected for reference in describing the structure of the component or to describe its interface or interaction with other components of the present invention, and the description may apply equally to other substantially similar or identical components within the system.

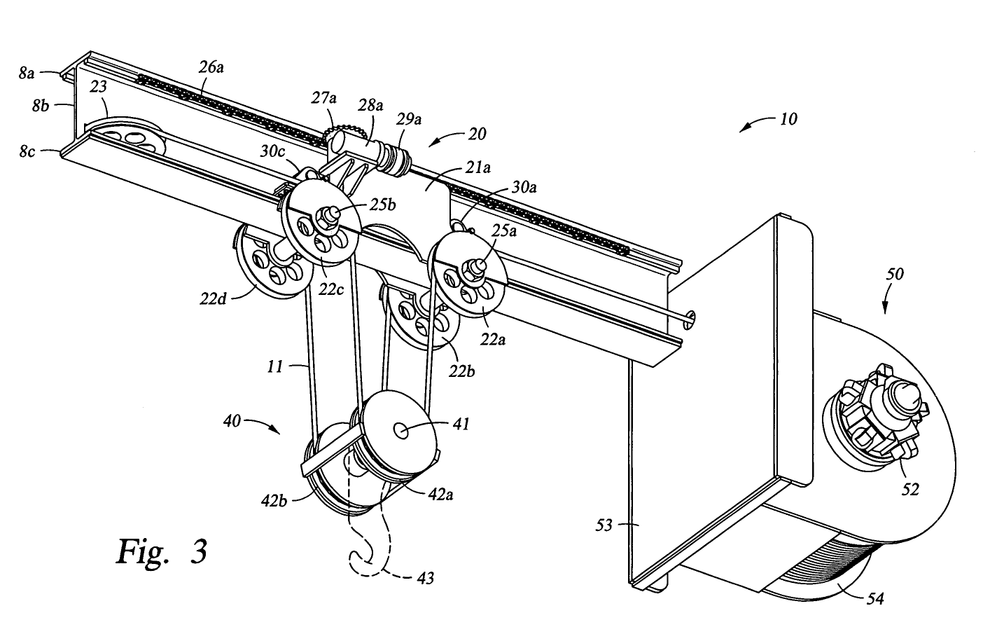

FIG. 3 is a perspective view of an embodiment of the improved hoist system of the present invention coupled to an I-beam. The I-beam 8 has a vertical center 8b, a top flange 8a and a bottom flange 8c. The hoist system 10 of a preferred embodiment of the present invention is adapted for coupling to and being supported by the I-beam bottom flange 8c and comprises a trolley 20 having a front trolley plate 21a, and a rear trolley plate 21b (not shown in FIG. 3). The trolley 20 is in rolling contact with the top side of the I-beam bottom flange 8c and travels along the length of the I-beam 8 from a position near the drum system 50 to a position near the equalizing sheave 23. The position and movement of the trolley 20 along the I-beam 8 is controlled using a trolley positioning system comprising a front positioning sprocket 27a, a front positioning gearbox 28a and a front positioning motor 29a.

Other components of the present invention include front proximal roller 30a, front distal roller 30c, wire rope 11, and four trolley sheaves including the front proximal trolley sheave 22a, rear proximal trolley sheave 22b, front distal trolley sheave 22c, rear distal trolley sheave 22d, a drum winch 52 and a spiral grooved drum 54. The equalizing sheave 23 equalizes the tension in and changes the direction of the movement of the wire rope 11. The wire rope 11 and the trolley sheaves 22a, 22b, 22c, 22d support the block 40 comprising the front and rear block sheaves 42a, 42b, both of which are received onto a block axle 41. The block axle 41 supports a load hook 43 (shown in outline form) used for coupling the block 40 to a load, such as a BOP stack (not shown in FIG. 3).

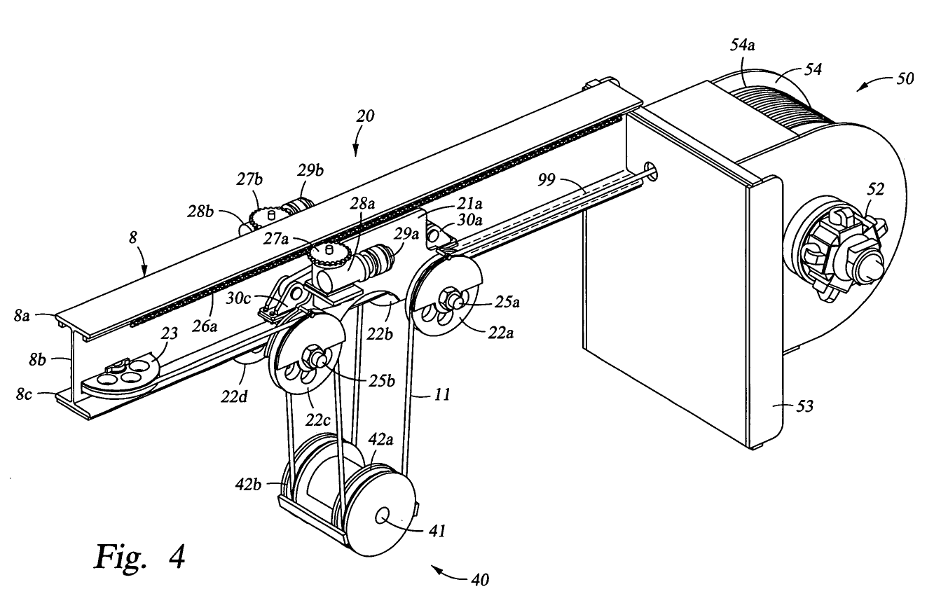

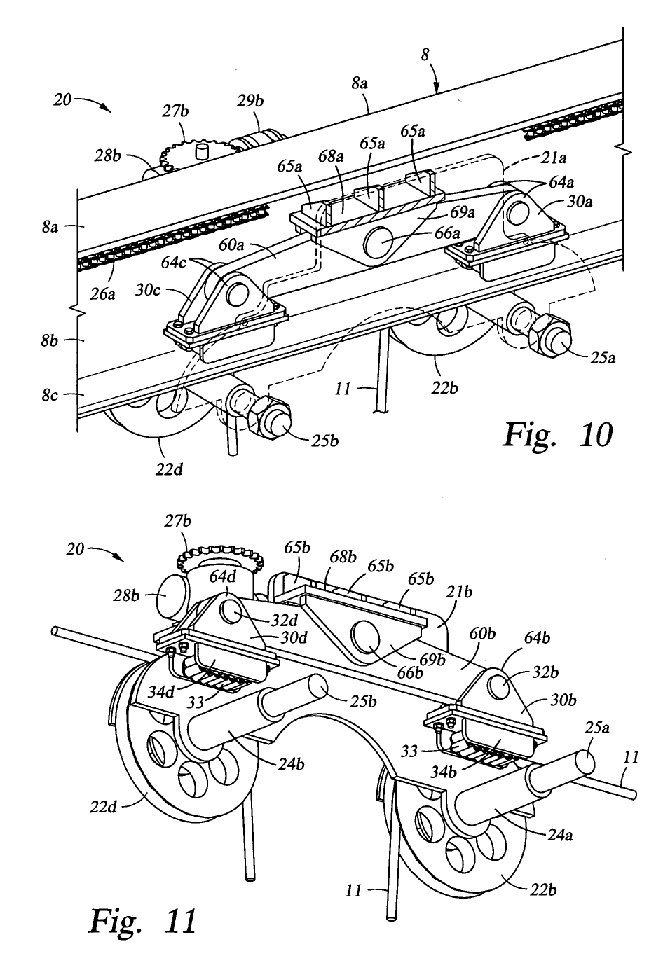

FIG. 4 is a perspective view of one embodiment of the improved hoist system of the present invention coupled to an I-beam. In this view from above the horizontal level of the I-beam 8, the front rollers 30a, 30c can be seen pivotally coupled to each end of an elongated member (not shown). This structure is described in greater detail in FIG. 10.

The trolley 20 comprises a plurality of components, most of which have counterparts located on opposite sides of the I-beam center portion 8b thereby making the trolley 20 generally symmetric with respect to the I-beam center portion 8b. As shown in FIG. 4, the trolley 20 has a front proximal roller 30a, a rear proximal roller 30b (not shown in FIG. 4), a front distal roller 30c and a rear distal roller 30d (not shown in FIG. 4). The front trolley plate 21a shown in FIG. 4 is supported by the front proximal roller 30a and the front distal roller 30c. The mechanisms and intervening components for coupling the front proximal roller 30a and the front distal roller 30c to the front trolley plate 21a, and for coupling the rear proximal roller 30b (not shown in FIG. 4) and the rear distal roller 30d (not shown in FIG. 4) to the rear trolley plate 21b (not shown in FIG. 4) are described in detail in relation to other drawings.

The front and rear trolley plates 21a, 21b support the front and rear trolley sheaves 22a, 22c, and 22b, 22d respectively, that, in turn, support the block 40 and the load (not shown in FIG. 4) through the wire rope 11. The front trolley plate 21a and the rear trolley plate 21b (not shown in FIG. 4) each have a pair of aligned apertures for receiving and supporting the proximal trolley axle 25a and the distal trolley axle 25b. It should be noted that the aligned apertures in the front and rear trolley plates 21a, 21b are positioned horizontally below the bottom surface of the I-beam bottom flange 8c when the trolley 20 is rollably engaged with an I-beam. The front proximal trolley sheave 22a and rear proximal trolley sheave 22b are rotatably received on the front and rear ends of the proximal trolley axle 25a, respectively, and the front distal trolley sheave 22c and rear distal trolley sheave 22d are rotatably received on the front and rear ends of the distal trolley axle 25b, respectively. The sheaves are coupled to the axles with friction reducing components, such as ball bearings.

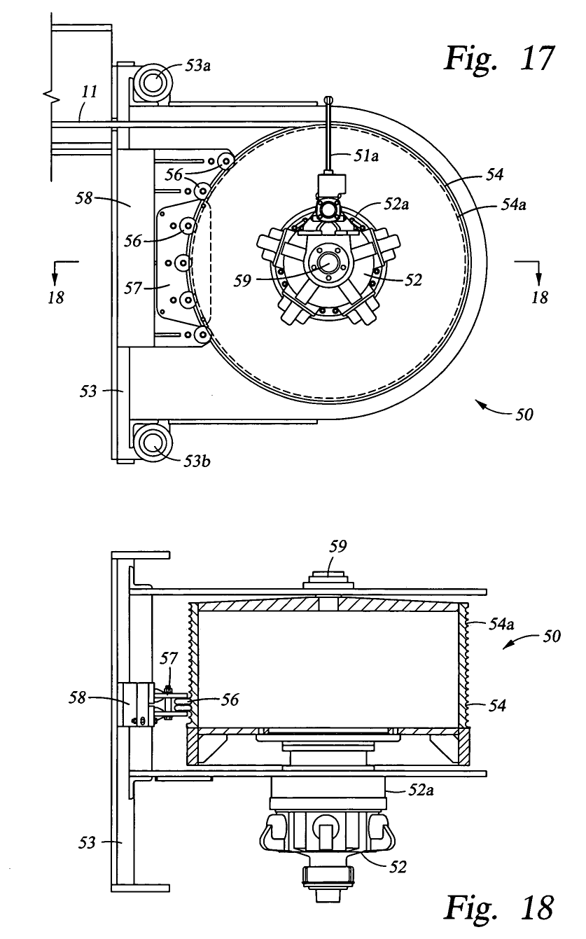

FIG. 4 also shows the drum system 50. The structure and operation of the drum system is described in greater detail in relation to FIG. 17 and FIG. 18. However, it should be noted that the purpose of the drum system 50 is to maintain the generally linear pathway 99 of the wire rope 11 between the top periphery of the circumferential groove of the front proximal trolley sheave 22a and the receiving portion of the spiral groove 54a on the circumference of the drum 54. The drum system 50 comprises a winch 52 and a grooved drum 54 comprising a spiral groove 54a of uniform pitch and depth on its circumference, the groove having a depth of more than one-third the diameter of the wire rope 11, and preferably about one-half the diameter of the wire rope 11. The winch 52 rotates the drum 54 to reel in or pay out the wire rope 11 so as to raise or lower the block 40 respectively. The winch 52 is operated by a primary drive system such as an air motor, hydraulic motor or electric motor. An example of a drive system is pressurized air supplied to the winch 52 through an air hose (not shown). The drum 54 and the winch 52 unit is slidably mounted on a stationary base 53 that allows the drum 54 to rotate as compelled by the winch 52 and gearbox (not shown in FIG. 4) combination and also to translate along its axis of rotation in a manner that provides uniform winding of the wire rope 11 within the spiral groove 54a. The diameter of the grooved drum 54 and the pitch of the spiral groove are selected to maintain the position of the wire rope pathway 99 generally static relative to the trolley 20. More specifically, the translation of the drum 54 along its axis of rotation maintains the pathway 99 of the wire rope 11 aligned with the receiving portion of the circumferential groove of the front proximal sheave 22a of the trolley 20. Translation of the drum 54 is controlled by the magnitude and direction of the force imparted by the roller-followers (see FIG. 17) against an edge of the portion of the spiral groove 52a in which the roller-followers engage the drum 54.

The tension of the wire rope 11 is generally uniform throughout the system. Referring to portions of the wire rope 11 in tension and between various components of the hoist system 10, the tension in the wire rope 11 at the first point at which the wire rope 11 contacts the groove 54a in the circumference of the drum 54 is substantially the same as the tension in the wire rope 11 between:

the front proximal trolley sheave 22a and the front block sheave 42a,

the front block sheave 42a and the front distal trolley sheave 22c,

the front distal trolley sheave 22c and the equalizing sheave 23,

the equalizing sheave 23 and the rear distal trolley sheave 22d,

the rear distal trolley sheave 22d and the rear block sheave 42b,

the rear block sheave 42b and the rear proximal trolley sheave 22b, and

the rear proximal trolley sheave 22b and the static end (not shown in FIG. 4) of the wire rope 11 where it terminates at the end of the I-beam 8 immediately adjacent to the drum 52.

The substantially equal tension in the wire rope 11 at each of the above-described segments results in the equalization of forces in the trolley 20 and unrestrained linear movement of the trolley 20 along the I-beam 8 to which the trolley 20 is movably secured, including when the trolley 20 supports a load.

Linear movement of the trolley 20 along the I-beam 8 is controllably implemented by operation of the front positioning sprocket 27a, front positioning gearbox 28a and front positioning motor 29a. The front positioning motor 29a may comprise an air-powered motor that is smaller and far less powerful than the motors used to drive chain pocket wheels in chain hoists because moving the trolley 40 does not require a large amount of force if the I-beam 8 is close to horizontal. A flexible air supply hose (not shown) supplies the pressurized air necessary to operate the front positioning motor 29a. The front positioning motor 29a will generally operate at high speed and low torque, thereby requiring a front positioning gearbox 28a to provide a low speed and higher torque rotation to the front positioning sprocket 27a. Again, the positioning gearbox 28a will be smaller and lighter than the gearboxes used to turn chain pocket wheels in chain hoists. The positioning sprocket 27a engages a linear chain 26a secured along the length of the I-beam 8. Positioning of the trolley 40 may be obtained using a variety of other positioning systems known in the art including rack and pinion, chain and sprocket, elliptical winch drum, screw drive or others.

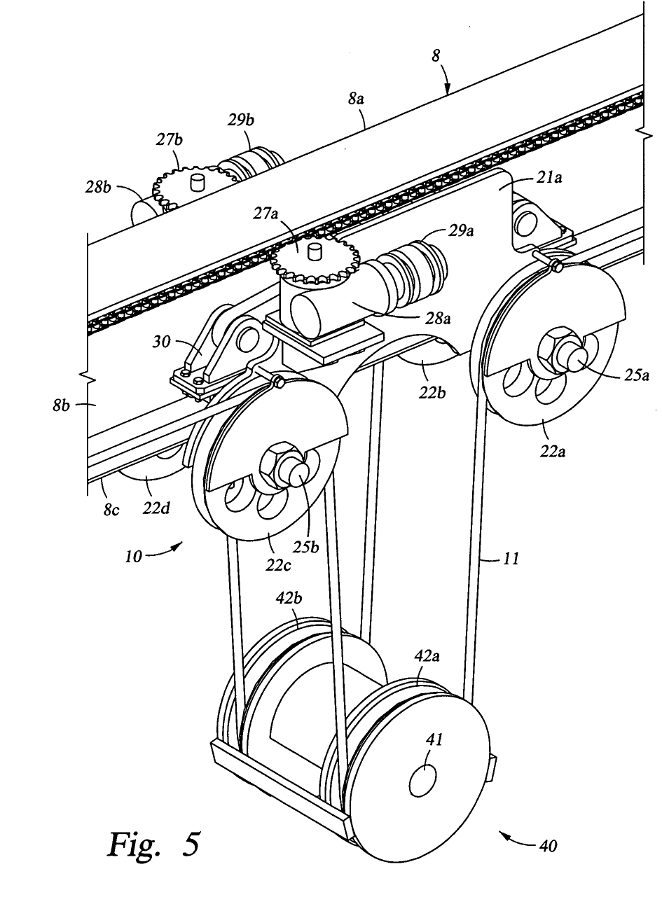

FIG. 5 is an enlarged perspective view of one embodiment of the trolley of the improved hoist system of the present invention coupled to an I-beam. FIG. 5 reveals two aspects of the present invention that contribute to vertical compactness of the hoist system 10. The absence of a winch or gearbox from the trolley 20 removes obstacles that would otherwise prevent the block 40 from being raised to a height at or near the I-beam bottom flange 8c. Also, the spacing between the front proximal trolley sheave 22a and the front distal trolley sheave 22c is sufficient to accommodate at least a portion of the block 40, and preferably most of the block 40, there between. Stated in terms of the trolley sheave diameters, the spacing between the proximal sheave axle 25a and the distal sheave axle 25b (center to center) equals or exceeds the sum of the average of the diameters of the front proximal trolley sheave 22a and the front distal trolley sheave 22d (which may be equal one to the other) plus the diameter of the block sheaves 42a, 42b. This configuration allows the block 40, when raised to its maximum height, to be disposed almost between the front proximal trolley sheave 22a and the front distal trolley sheave 22c, thereby expanding the vertical range of operation of the hoist system 10.

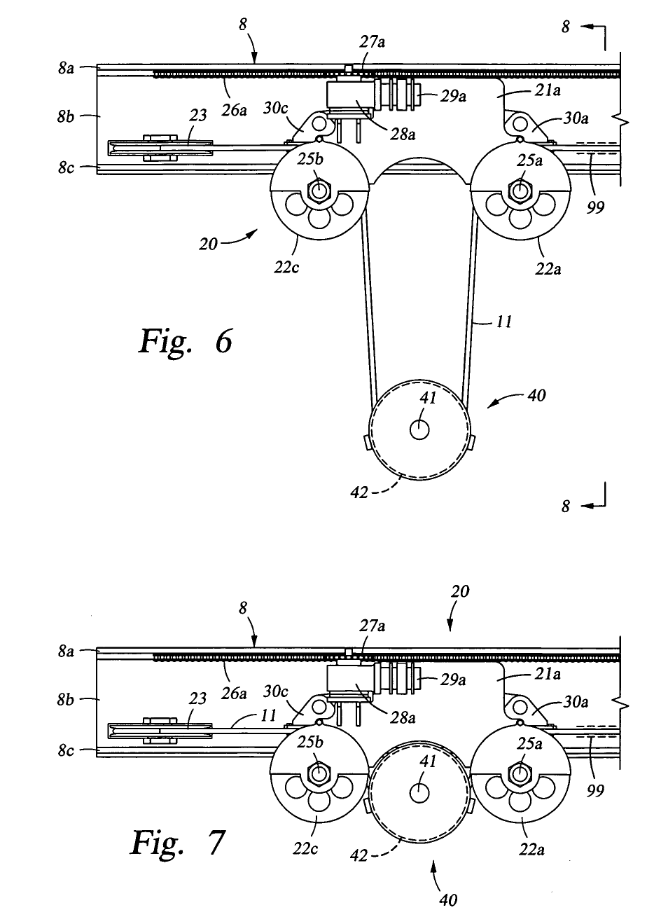

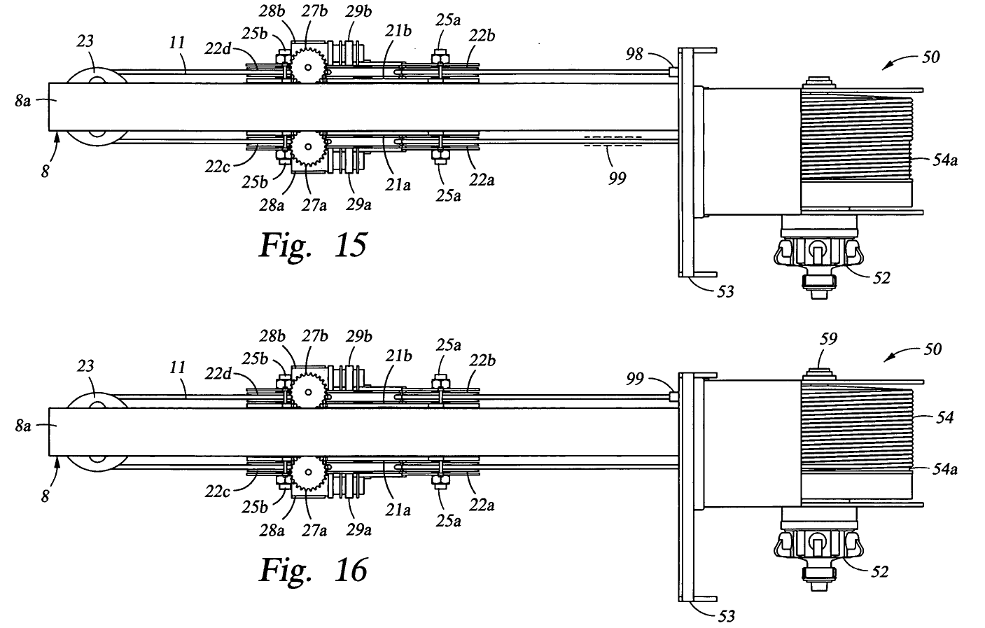

FIG. 6 is an elevation view of one embodiment of the trolley 20 of the improved hoist system of the present invention coupled to an I-beam 8 with the block 40 at a position lower than its maximum height. This configuration corresponds to FIG. 15, wherein a substantial portion of the wire rope 11 has been paid out from the spiral groove 54a. FIG. 6 shows the relationship between the trolley sheaves 22a, 22b, 22c, 22d and the equalizing sheave 23. As stated earlier, the generally linear pathway 99 of the wire rope 11 between the front proximal trolley sheave 22a and the drum system 50 (not shown in FIG. 6) is generally aligned with the portion of the wire rope 11 between the front distal trolley sheave 22c and the equalizing sheave 23. This pathway is parallel and horizontally even with the corresponding wire rope pathways that are hidden from view in FIGS. 6 and 7 by the I-beam 8. That is, the pathway of the wire rope 11 between the front proximal trolley sheave 22a and the drum system 50 is parallel and horizontally even with the portion of the wire rope 11 between the rear proximal trolley sheave 22b (not shown) and the static end of the wire rope (not shown), and the portion of the wire rope pathway between the front distal sheave 22b and the equalizing sheave 23 is parallel and horizontally even with the portion of the wire rope pathway between the rear distal trolley sheave 22d and the equalizing sheave 23.

FIG. 7 is an elevation view of one embodiment of the trolley 20 of the improved hoist system of the present invention coupled to an I-beam 8. This position corresponds to the configuration of the drum 54 shown in FIG. 16, wherein much of the wire rope 11 is stored on the grooved drum 54. FIG. 7 shows the block 40 raised to its maximum height with a substantial portion of the block sheaves 42a, 42b disposed generally within the space between the front proximal trolley sheave 22a and the front distal trolley sheave 22c. In this position, the maximum amount of wire rope 11 is stored on the drum system 50 (not shown in FIG. 7), and the drum 54 is translated to its extreme position along the axis of rotation of the drum 54 (see FIG. 16) in order to maintain alignment of the groove 54a that receives the wire rope 11 with the circumferential groove at the top periphery of the front proximal trolley sheave 22a.

FIG. 8 is an end view of one embodiment of the trolley 20 of the improved hoist system of the present invention coupled to an I-beam 8 with the block 40 at a position lower than its maximum height. The front proximal roller 30a is shown opposite the I-beam center portion 8b from the rear proximal roller 30b. Both the front proximal roller 30a and the rear proximal roller 30b are shown in rolling contact with the top side of the I-beam bottom flange 8c. The front proximal roller assembly 30a is pivotally coupled to the proximal end of the front trolley support 60a, and the rear proximal roller 30b is pivotally coupled to the proximal end of the rear trolley support 60b. The front trolley support 60a is, in turn, pivotally coupled, at its center, to the front trolley plate 21a and the rear trolley support 60b is pivotally coupled to the rear trolley plate 21b. The front proximal roller assembly 30a and the rear proximal roller assembly 30b each have a pair of upwardly extending and generally parallel mounting ears 64a, 64b that each receive an end of a trolley support 60a, 60b into the space between the ears 64a, 64b. The front proximal roller 30a, for example, has a pin is inserted through aligned apertures in the ears 64a of the front proximal roller 30a and in the proximal end of the trolley support 60a to pivotally couple the front proximal roller 30a to the proximal end of the trolley support 60a, as shown in FIG. 10. In the same configuration, the rear proximal roller 30b is pivotally coupled to the proximal end of the rear trolley support 60b. This allows the front proximal roller 30a to articulate about the pivoting coupling to the proximal end of the trolley support 60a maintain stability in the trolley 20 where irregularities in the top surface of the I-beam bottom flange 8c occur. The rear proximal roller 30b is similarly pivotally coupled to the proximal end of the rear trolley support 60b, and the front distal roller 30c and the rear distal roller 30d are similarly pivotally coupled to the distal ends of the front trolley support 60a and the rear trolley support 60b, respectively.

Similarly, the front and rear trolley supports 60a, 60b each have an aperture at their apex or center for pivotally coupling of the front and rear trolley supports to the front and rear trolley plates 21a, 21b, respectively. The front and rear riders, 68a and 68b, are portions of the front and rear trolley plates 21a, 21b structured for providing a robust pivotal coupling to the trolley supports 21a, 21b. The apertures in the centers of the front and rear trolley supports 60a, 60b are each received between and aligned with apertures in the downwardly descending and generally parallel ears 69a, 69b of the front and rear riders 68a, 68b. Retaining pins are received into aligned apertures to thereby pivotally couple the front and rear trolley supports 60a, 60b to the front and rear trolley plates 21a, 21b, respectively. This further contributes to the dynamic stability of the trolley 20 by allowing the front and rear trolley supports 60a, 60b to articulate about the pivoting coupling with the trolley plates 21a, 21b, respectively. The dual articulating structure, comprising a pair of articulating rollers 30a, 30c and 30b, 30d pivotally coupled to each of two trolley supports 60a, 60b which are, in turn, each pivotally coupled to a trolley plate 21a, 21b, provides a minimum transfer to the block 40 of unwanted motion that may result from surface irregularities or deformation in the top surface of the I-beam bottom flange 8c.

FIG. 8 further shows an end view of the front and rear riders 68a, 68b that provide a robust static coupling of the front and rear trolley plates 21a, 21b to the front and rear trolley supports 60a, 60b, respectively. Using the front rider 68a as an example, and referring now to FIG. 10, the front rider 68a is welded (along the cross-hatched area) to the front trolley plate 21a (shown in outline form in FIG. 10). Gussets 65a are welded into place to add stiffness and rigidity to the coupling. The center of the front trolley support 60a is received into the space between the downwardly extending ears 69a of the front rider 68a. A pin is received into the aligned apertures in the ears 69a of the front rider 68a and the front trolley support 60a to pivotally couple the front trolley support 60a to the trolley plate 21a (shown in outline form in FIG. 10).

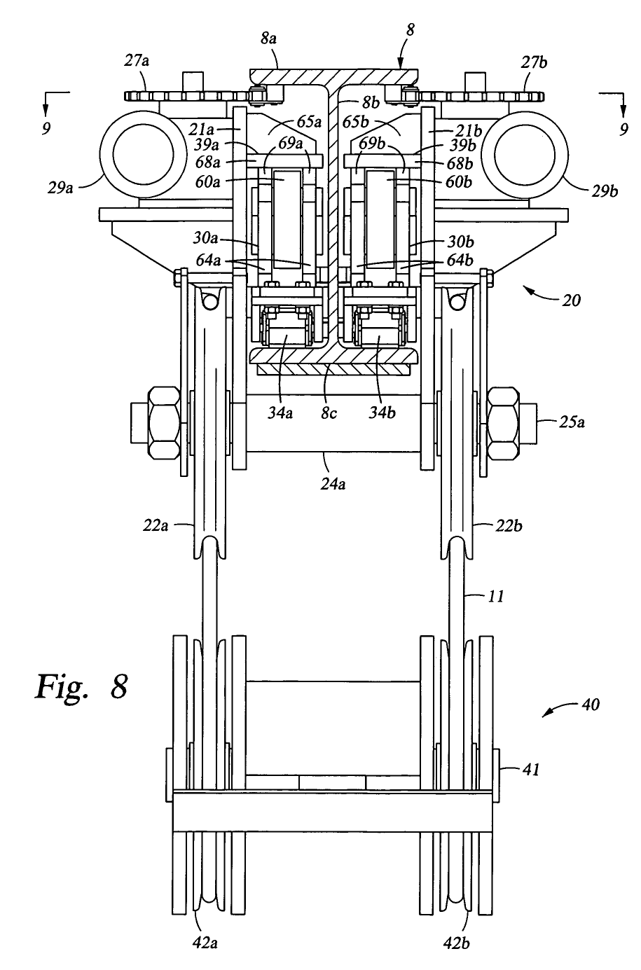

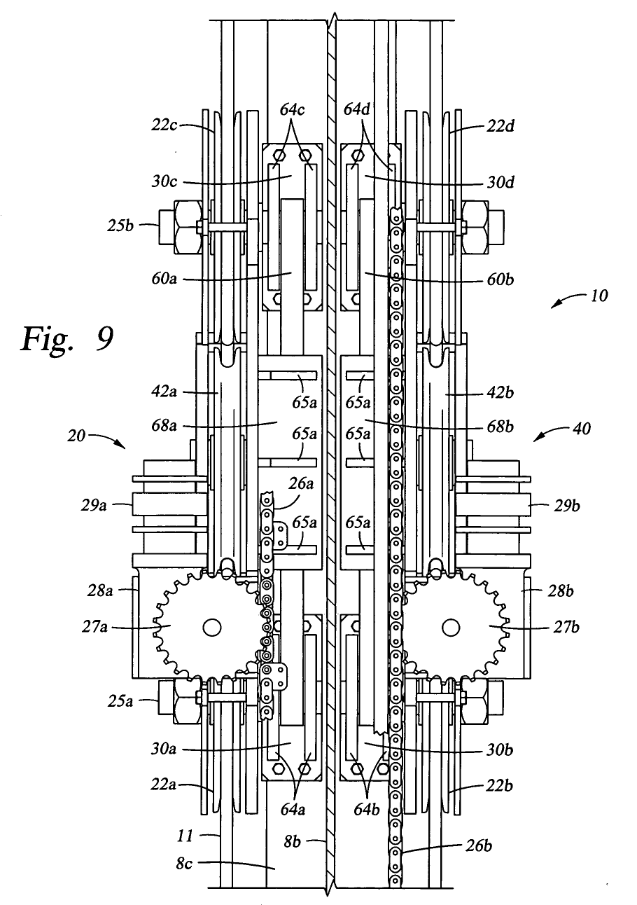

FIG. 9 is an overhead view of one embodiment of the trolley 20 of the improved hoist system 10 of the present invention. FIG. 9 shows the pivotal coupling of the front proximal roller 30a to the proximal end of the front trolley support 60a, the pivotal couplings between the front distal roller 30c and the distal end of the front trolley support 60a, the pivotal coupling between the rear proximal roller 30b and the proximal end of the rear trolley support 60b, and the pivotal coupling between the rear distal roller 30d and the distal end of the rear trolley support 60b. FIG. 9 also shows the overhead view of the front rider 68a and the rear rider 68b, and the front and rear sets of gussets 65a, 65b thereon, respectively.

FIG. 10 is a perspective view of a portion of one embodiment of the of the trolley 20 of the improved hoist system of the present invention in rolling contact with the top side of an I-beam bottom flange 8c. The trolley plate 21a is shown in outline only in FIG. 10, and the trolley positioning system comprising the front positioning motor 29a, the front positioning gearbox 28a and the front positioning sprocket 27a are removed from FIG. 10 to reveal the structure and pivoting couplings of the front proximal and front distal rollers 30a, 30c. FIG. 10 reveals the pivoting coupling of the front proximal roller 30a with the proximal end of the trolley support 60a, and the pivoting coupling of the front distal roller 30c with the distal end of the trolley support 60a. FIG. 10 also reveals the pivoting coupling between the center of the front trolley support 60a and the trolley plate 21a (shown in dotted line only to reveal the hidden structure behind it).

FIG. 11 is a perspective view of one side of one embodiment of the trolley portion of the improved hoist system of the present invention. The roller assemblies 30b, 30d of the trolley 20 each comprise a set of caterpillar bearings 33 captured in generally fixed pattern within their bearing housings 34b, 34d. The caterpillar bearings 33 provide uniform load distribution along a plurality of generally parallel, elongated roller bearings 33 secured within the housing 34b, 34d. The housings 34b, 34d allow the roller bearings to roll and cycle around the pattern following a generally elliptical path within the housing. The housings containing the caterpillar bearings are secured to the pair of upwardly extending ears 64b, 64d. The ears 64b, 64d have apertures aligned to receive a pin 32b, 32d to pivotally couple the rollers 30b, 30d to the proximal and distal ends of trolley support 60b.

The trolley plate 21b extends below the bottom surface of the bottom flange 8c of the I-beam 8 so that the opposing trolley plates 21a, 21b positioned on opposite sides of the I-beam center 8b can be secured one to the other in a fixed and generally parallel relationship. The embodiment shown in FIG. 8 shows how the trolley plates are secured in a fixed relationship. In this embodiment, the axles 25a, 25b (not shown in FIG. 8) and spacers 24a, 24b (not shown in FIG. 8) secure the trolley plates 21a, 21b into place relative to each other, each axle penetrating corresponding apertures in the trolley plates 21a, 21b. This arrangement opposes the torque on each trolley plate 21a, 21b imparted by supporting the forces of the rollers 30.

The front trolley plate 21a, the front proximal trolley sheave 22a, front distal trolley sheave 22c, front trolley positioning motor 29a, front positioning gearbox 28a, front positioning sprocket 27a and the I-beam 8 are all removed from FIG. 11 to reveal the structure and interaction of the rear proximal roller 30b and the rear distal roller 30d with the rear trolley support 60b. The pivoting couplings of both the rear proximal roller 30b with the proximal end of the rear trolley support 60b and the rear distal roller 30d with the distal end of the rear trolley support 60b, respectively, are shown in FIG. 11. These pivotal couplings at the ends of the rear trolley support 60b include pins 32b, 32d. Also visible in FIG. 11 are the individual elongated caterpillar bearings 33 that are captured in a bearing housings 34b, 34d for providing rolling contact between the trolley 20 and the top side of the I-beam bottom flange (not shown in FIG. 11—refer to FIG. 10, element 8c).

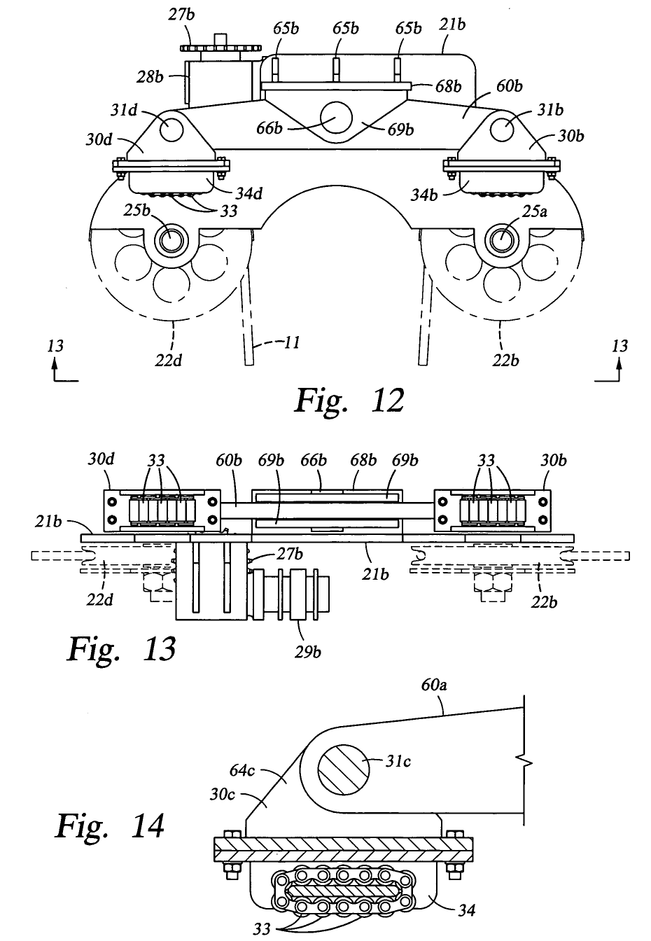

FIG. 12 is an elevation view of one side of one embodiment of the trolley support structure of the improved hoist system of the present invention showing the pivotal coupling between the rear trolley support 60b and the rear trolley plate 21b that supports the rear proximal and distal sheaves 22b, 22d. The front trolley plate 21a, the front proximal trolley sheave 22a, front distal sheave 22c, trolley positioning motor 29a, positioning gearbox 28a, positioning sprocket 27a and the I-beam 8 are all removed from FIG. 12 to reveal the structure and interaction of the rear proximal roller 30b, rear distal roller 30d with the rear trolley support 60b. FIG. 12 shows the pivotal connection between the rear trolley support 60b and the rear trolley plate 21b. The coupling must withstand a large moment that is created by the separation between the front and rear sheaves of the trolley. That is, the vertically downward load on the front proximal trolley sheave 22a and the front distal trolley sheave 22c as a result of the tension in the wire rope 11, plus the upward force on the front proximal roller 30a and the front distal roller 30c, results in a moment tending to rotate the front portion of the trolley 20 in the counterclockwise direction when viewing FIG. 8. Similarly, but oppositely, the vertically downward load on the rear proximal trolley sheave 22b and the rear distal trolley sheave 22d as a result of the tension in the wire rope 11, plus the upward force on the rear proximal roller 30b and the rear distal roller 30d, results in a moment tending to rotate the rear portion of the trolley 20 in the clockwise direction when viewing FIG. 8. Accordingly, the structure of the couplings of the front trolley plate 21a with the front trolley support 60a and the rear trolley plate 21b with the rear trolley support 60b must be sufficiently robust to withstand these large moments.

Referring back to FIG. 10, the front rider 68a comprises a plate and a plurality of gussets 65a distributed in a generally uniform distribution thereon. The front rider 68a also comprises a pair of downwardly extending and parallel ears 69a having aligned apertures for receiving a pin 66a for pivotally coupling the front trolley support 60a to the rider 68a. The rider 68a is statically coupled to the trolley plate 21a (shown on FIG. 10 in outline only). The surfaces of the front rider 68a (shown as cross-hatched in FIG. 10) shows the surfaces at which the rider 68a may be welded to the trolley plate 21a (shown in outline form in FIG. 10) along the front rider plate 68a and the gussets 65a. This structure provides a robust pivotal coupling of the front trolley support 60a to the front trolley plate 21a.

As stated earlier, the loads on the front proximal roller 30a (not shown in FIG. 12) and the front distal roller 30c (not shown in FIG. 12) are transferred, through pivotal couplings, to the front trolley support 60a (not shown in FIG. 12), and the corresponding loads on the other side of the I-beam center portion 8b on the rear proximal roller 30b and the rear distal roller 30d are transferred, through pivotal couplings, to the rear trolley support 60b.

FIG. 13 is a bottom view of one side of one embodiment of the rear trolley support 60b of the trolley 20 of the improved hoist system of the present invention. FIG. 13 shows the spaced-apart relationship of the rear proximal roller 30b and the rear distal roller 30d. FIG. 13 also shows the center portion of the rear trolley support 60b being received between and pivotally coupled with the downwardly extending ears 69b of the rear rider 68b. The pivotal coupling of the rear trolley support 60b with the rear rider 68b is provided by the pin 66b received within aligned apertures in the ears 69b of the rear rider 68b and in the center portion of the rear trolley support 60b received within the space between the ears 69b.

FIG. 14 is an enlarged elevation view of a front distal roller 30c pivotally coupled to the distal end of the front trolley support 60a. The front distal roller 30c is pivotally coupled to the distal end of the front trolley support 60a by receiving a pin 31c into aligned apertures in the upwardly extending, parallel ears 64c of the front distal roller 30c and in the distal end of the front trolley support 60a that is received into the space between the ears 64c. The elongated roller bearings 33 are captured within a roller assembly housing 34c and thereby constrained in a configuration that allows the roller bearings 33 to circulate within the housing in a generally elliptical path as they individually rotate about their longitudinal axis. Caterpillar bearings of this type are commercially available and can be obtained from Hillman Rollers, 12 Timber Lane, Marlboro, N.J. 07746 and other sources.

FIG. 15 is an overhead view of one embodiment of the improved hoist system of the present invention with the block 40 at a position lower than its maximum height as evidenced by the length of wire rope 11 paid out from the spiral groove 54a in the circumference of the drum 54. The winch 52 is used to controllably rotate the drum 54 to reel in the wire rope 11 to raise the block 40 (not shown in FIG. 15). As the drum 54 is controllably rotated by the winch 52, the wire rope 11 is reeled in and stored on the drum 54 in the spiral groove 54a thereon. As the wire rope is reeled in and stored on the drum 54, the drum 54 translates along its axis of rotation to maintain alignment of the wire rope pathway 99 with the receiving portion of the groove 54a and to maintain the pathway in a substantially fixed relationship with the I-beam 8. The static end 98 of the wire rope 11 may be fixed to any of a number of devices known in the art for securing the end of a wire rope.

FIG. 16 is an overhead view of one embodiment of the improved hoist system of the present invention with the block at its maximum height as evidenced by the length of wire rope stored on the grooved drum 54 and the corresponding translation of the grooved drum 54 along its axis of rotation. This configuration corresponds to FIG. 7, an elevational view with the block 40 at its maximum height. Referring again to FIG. 16, the drum 54 is shown to have moved along its axis of rotation to its extreme position (in the direction of the rear side of the I-beam) in order to maintain general alignment of the wire rope pathway 99 (not shown in FIG. 16).

FIG. 17 is an end view of the drum system 50 of one embodiment of the present invention with the winch 52 and a gearbox 52a coupled to the drum 54, and the roller-followers 56 rollably engaging the trough of the spiral groove 54a of the drum 54. The drum 54 translates as compelled by the force imparted by the roller-followers 56 against the edge of the spiral groove 54a in the drum 54. The translation of the drum 54 along its axis of rotation is causes the slidable mounting 53 of the drum to slide along translation the beams 53a, 53b.

FIG. 18 is an overhead view of the drum system 50 of the present invention with the winch 52 and gearbox 52a operatively coupled to the drum 54. The drum 54 is slidably mounted on a stationary base 53. The base 53 supports the roller-follower plate 57. The roller-followers 56 are secured to the roller-follower plate 57 in positions to maintain rolling contact with the trough of the spiral groove 54a at multiple points of contact about the circumference of the drum 54. The roller-follower plate 57 remains stationary relative to the rotating and translating drum 54, and is shimmed into firm engagement with the drum using shims 58 to rollably engage the spiral groove 54a in the drum 54. It should be noted that the engagement of the roller-followers with the trough of the spiral groove 54a occurs at a portion of the drum 54 where wire rope 11 is not stored. As the wire rope 11 is reeled in for storage on the drum (as shown in FIG. 16), the roller-followers 56 will advance along the spiral groove 54a with rotation to created corresponding translation of the drum 54, always remaining within a portion of the spiral groove 54a that is not then being used to receive or store wire rope 11. For this reason, in the embodiment used in the drawings referenced above, the length of the spiral groove 54a should exceed the length of stored wire rope 11 reeled therein by at least one circumference of the drum 54 to prevent interference between the wire rope 11 and the roller-followers 56. It should be noted that the controlled translation and positioning of the rotating drum 54 in accordance with drum rotation can be achieved using screw drive systems, servo-motors, rack and pinion, chain and sprocket, elliptical winch drum or other systems known in the mechanical arts for positioning.

The terms “comprising,” “including,” and “having,” as used in the claims and specification herein, shall be considered as indicating an open group that may include other elements not specified. The term “consisting essentially of,” as used in the claims and specification herein, shall be considered as indicating a partially open group that may include other elements not specified, so long as those other elements do not materially alter the basic and novel characteristics of the claimed invention. The terms “a,” “an,” and the singular forms of words shall be taken to include the plural form of the same words, such that the terms mean that one or more of something is provided. For example, the phrase “a solution comprising a phosphorus-containing compound” should be read to describe a solution having one or more phosphorus-containing compound. The terms “at least one” and “one or more” are used interchangeably. The term “one” or “single” shall be used to indicate that one and only one of something is intended. Similarly, other specific integer values, such as “two,” are used when a specific number of things is intended. The terms “preferably,” “preferred,” “prefer,” “optionally,” “may,” and similar terms are used to indicate that an item, condition or step being referred to is an optional (not required) feature of the invention.

It should be understood from the foregoing description that various modifications and changes may be made in the preferred embodiments of the present invention without departing from its true spirit. The foregoing description and drawings are provided for the purpose of illustration only and should not be construed in a limiting sense. Only the language of the following claims should limit the scope of this invention.

What is claimed is:

1. A hoist system for a rig, comprising:
a drum having a groove on a circumference of the drum for receiving and storing a portion of a wire rope, wherein the drum is rotatably coupled to a winch;
a trolley adapted for rollably coupling to a beam and supporting a first pair and a second pair of independently rotatable trolley sheaves, the first pair of trolley sheaves adjacent one to the other and located opposite the trolley from the second pair of trolley sheaves, each trolley sheave rotatable about an axis of rotation that is aligned with the axis of rotation of the opposite trolley sheave, and each trolley sheave rotatably supported by the trolley;
a block adapted for supporting a load and having a pair of block sheaves rotatably secured therein, the block sheaves having aligned axes of rotation;
a wire rope having at least one active end and a remote end, the active end being received into at least a portion of the groove on the circumference of the drum, and the wire rope engaging the trolley and the block intermediate the active end and the remote end;
wherein the wire rope engages a block sheave intermediate its engagement with the first trolley sheave pair and the wire rope engages a block sheave intermediate its engagement with the second sheave pair;
wherein the wire rope engages a tension equalizing sheave intermediate its engagement with the pair of block sheaves; and
wherein the block is raised when the drum rotates to reel in the wire rope and the block is lowered when the drum rotates to pay out the wire rope.

2. The hoist system of claim 1, wherein the groove is a spiral groove.

3. The method of claim 1, wherein the axes of the pairs of trolley sheaves are sufficiently spaced apart to accommodate at least a portion of the block sheave therebetween.

4. The method of claim 3 wherein the portion of the block sheave comprises a substantial majority.

5. The method of claim 1, wherein the remote end of the wire rope is static.

6. A hoist system for a rig comprising:
a drum having a groove on its circumference for receiving and storing a portion of a wire rope, the drum being rotatably coupled to a winch;
a trolley adapted for rollably coupling to a beam and supporting a first pair and a second pair of independently rotatable trolley sheaves, the first pair of trolley sheaves adjacent one to the other and located opposite the trolley from the second pair of trolley sheaves, each trolley sheave rotatable about an axis of rotation that is aligned with the axis of rotation of the opposite trolley sheave, and each trolley sheave rotatably supported by the trolley;
a block adapted for supporting a load and having a pair of block sheaves rotatably secured therein, the block sheaves having aligned axes of rotation;
a wire rope having at least one active end and a remote end, the active end being received into at least a portion of the groove on the circumference of the drum, and the wire rope engaging the trolley and the block intermediate the active end and the remote end;
a drum adapted for rotation on an axis by a winch and slidably received onto a base and having a groove no its circumference for receiving and storing the wire rope upon rotation of the drum in one direction and for paying out wire rope from the groove when upon rotation in the reverse direction;
at least one roller-follower engaging the groove and adapted for imparting translation of the drum along its axis of rotation to maintain substantially no fleet angle on the portion of the wire rope between the trolley and the drum;
wherein the wire rope engages a block sheave intermediate its engagement with the first trolley sheave pair and the wire rope engages a block sheave intermediate its engagement with the second sheave pair;
wherein the wire rope engages a tension equalizing sheave intermediate its engagement with the pair of block sheaves; and
wherein the block is raised when the drum rotates to reel in the wire rope and the block is lowered when the drum rotates to pay out the wire rope.
